(19) United States
(12) Patent Application Publication
(10) Pub. No.: US 2009/0103305 A1
(43) Pub. Date: Apr. 23, 2009

(54) HIGH-PRESSURE GAS DISCHARGE LAMP

(75) Inventor: Arnd Ritz, Heinsberg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,808

(22) PCT Filed: Dec. 21, 2004
(86) PCT No.: PCT/IB2004/052876

§ 371 Date: Nov. 10, 2008

(30) Foreign Application Priority Data
Jan. 6, 2004 (EP) 04100010.0

(51) Int. Cl. F21V 29/00; H01J 61/52

(52) U.S. Cl. 362/294; 313/46

(57) ABSTRACT

The invention relates to a high-pressure gas discharge lamp which has at least a lamp bulb (2) which hermetically seals off a gas-filled discharge space (21), which lamp bulb (2) has at least a region (3) which does not and/or does not directly serve for the desired light emission of the high-pressure gas discharge lamp, wherein a thermally conducting material is provided which has a higher thermal conductivity than the material Of the lamp bulb (2).

The invention relates to a high-pressure gas discharge lamp which comprises at least a lamp bulb which hermetically seals off a gas-filled discharge space, which lamp bulb has at least one region which does not and/or does not directly serve for the desired light emission of the high-pressure gas discharge lamp.

Regions of the lamp bulb which do not serve directly for the desired light emission of the high-pressure gas discharge lamp may be, for example, coatings or reflectorized portions. These are often made impermeable or partly impermeable at least to visible light or a portion thereof. If this region, for example, reflects light into the lamp bulb, it may serve indirectly for providing the desired light emission.

Regions of the lamp bulb which do not primarily serve for the desired light emission of the high-pressure gas discharge lamp may fulfill other functions of the lamp which achieve, for example, also a reduction in the quantity of light but improve lamp life, or the like.

In all cases the outer surface of the lamp bulb has a region which directly serves for the desired light emission of the high-pressure gas discharge lamp, for example in the form of a light emission window.

High-pressure gas discharge lamps (HID or high intensity discharge lamps) and in particular UHP or ultra high performance lamps are preferred for use inter alia in projection applications because of their optical properties.

A light source which is point-shaped as much as possible is required for these applications, so that the discharge arc arising between the electrode tips should not exceed a length of approximately 0.5 to 2.5 mm. Furthermore, a luminous intensity which is as high as possible in combination with as natural as possible a spectral composition of the light is usually desired.

These properties can be best achieved with UHP lamps at present. The development of these lamps, however, must fulfill two essential requirements at the same time:

on the one hand, the highest temperature at the inner surface of the discharge space must not become so high that a devitrification of the lamp bulb occurs, the latter usually being made of quartz glass. This may constitute a problem because the strong convection inside the discharge space of the lamp heats the region above the discharge arc particularly strongly. There is accordingly an inhomogeneous temperature distribution in the discharge space at least during the gas discharge and immediately afterwards.

On the other hand, the coldest spot on the inner surface of the lamp bulb in the region of the discharge space must still have such a high temperature, for example approximately1200 K, that a mercury pressure of approximately 200 bar can be achieved, such that the mercury will not deposit there but remains overall in the evaporated state to a sufficient degree. This is to be heeded in particular in lamps with saturated gas fillings.

These two mutually conflicting requirements have the result that the maximum admissible difference between the highest and the lowest temperature on the inside of the lamp bulb, in particular in dependence on the relevant lamp type and its mounting situation, is a given factor. This temperature range, which is a requirement in all cases and which is dependent inter alia on the relevant lamp type, is bounded by the maximum temperature at the outer surface of the discharge space, i.e. the inner side of the lamp bulb in that location, and by the lowest temperature at the outer surface of the discharge space.

This difference, for example, often has values around approximately 120 K in UHP lamps with a reflecting partial coating on the lamp bulb in accordance with the teachings of DE 101 51 267 A1. The highest and the lowest temperature are mutually dependent, in particular in small, highly loaded discharge lamps, and may lead to problems in the adjustment of an optimum lamp operation with a sufficiently long lamp life in certain applications.

The discharge space must be so small that a sufficient amount of energy reaches the coldest spot, particular owing to heat conduction, so as to keep the relevant minimum temperature of the coldest spot on the inner surface of the discharge space high enough.

Commercially available UHP lamps usually keep within the required temperature ranges of approximately 1200 K to approximately 1400 K when operated at rated power. It is desirable, however, to widen the possible field of application, for example to achieve a dimming possibility of the lamp or to upgrade a lamp type for applications with a higher lumen output. In the case of dimming, the temperature of the coldest spot must not drop below the minimum temperature. In the case of a power increase, the temperature of the hottest spot must not exceed the maximum temperature. It is apparent from the above interrelationships that the design of the UHP lamp can be simplified and that the field of application can be widened if suitable measures can be taken to reduce the temperature difference between the coldest and the hottest spot.

There is a similar demand for widening the field of application in cases where a cooling is comparatively difficult or technically complicated to achieve, for example in applications with gastight reflectors.

It is a known procedure to cool lamps by means of a directed flow of air so as to be able to operate the lamp at an increased power. Air is then blown against the hottest spot of the lamp bulb, so that an overheating, i.e. to above the maximum temperature, is avoided. It is a disadvantage thereof that special arrangements for generating and directing the air flow are required in order to realize this cooling. These arrangements cause additional expense, are to be accommodated in a device, and may cause additional noise.

Also known, for example from DE 101 51 267 A1, is the use of greater wall thicknesses for the lamp bulb, in particular in the region of the discharge space. This increases the thermal conductivity along the wall of the lamp bulb and achieves an improved heat transfer to the outer surface of the lamp bulb. These increased wall thicknesses, however, lead to an increased lamp diameter, which has a negative effect in particular in small reflectors because of increased shadow effects. Furthermore, more expense is required for avoiding imaging defects of the lamp bulb because the geometries of thicker lamp bulbs often lead to higher expense in the manufacturing process.

The object of the invention accordingly is to provide a high-pressure gas discharge lamp of the kind mentioned in the opening paragraph which has a smaller temperature difference between the hottest and the coldest spot, such that these two temperature values lie within the required temperature region between the minimum and the maximum temperature. The relevant solution is to be technically simple and feasible for industrial mass production.

The object of the invention is achieved by means of a high-pressure gas discharge lamp which comprises at least a lamp bulb which hermetically seals off a gas-filled discharge space, which lamp bulb has at least one region which does not and/or does not directly serve for the desired light emission of the high-pressure gas discharge lamp, wherein a thermally conducting material is provided which has a higher thermal conductivity than the material of the lamp bulb.

The provision according to the invention of the thermally conducting material, which has a higher thermal conductivity than the material of the lamp bulb, achieves at least a partial temperature equalization in the region of the outer surface of the lamp bulb in particular owing to the thermal conduction in the thermally conducting material. This temperature equalization in particular achieves a reduction in the higher temperatures and an increase in the lower temperatures preferentially in that region of the lamp bulb which is directly influenced by the corresponding region of the thermally conducting material. The temperature conditions of the other regions of the lamp bulb are influenced at least indirectly, in particular owing to the effects of the thermal conduction in the lamp bulb. The result is a reduction of the temperature difference between the highest and the lowest temperature.

The influence on this temperature difference according to the invention, i.e. the reduction in this temperature difference, depends inter alia on the relevant lamp type, on the size and arrangement of the region or regions of the thermally conducting material, and on the thermal conduction coefficient of the thermally conducting material. The degree of the influence is accordingly different for different cases, for example this degree increases with an increasing size of the thermally conducting material.

The design of the relevant high-pressure discharge lamp may be simplified and/or the relevant operating range may be widened in dependence on the degree of this influence on the temperature difference.

The dependent claims 2 to 7 relate to advantageous further embodiments of the high-pressure discharge lamp according to the invention.

It is preferred that the high-pressure discharge lamp is a UHP lamp. The discharge space in this lamp type is filled with a quantity of mercury, such that a mercury vapor pressure of, for example, above 200 bar is generated in the discharge space in the case of full evaporation. This high pressure is necessary here for achieving the satisfactory luminous intensity and spectral distribution of the UHP lamp. This vapor pressure, however, can only be maintained above a certain temperature of approximately 1200 K along the entire inner wall of the discharge vessel. When the inner temperature undershoots the required minimum temperature in a location, mercury will condense in this location, so that the pressure drops and the lamp data deteriorate. A part of the energy converted in the discharge arc of the lamp reaches the surface of the discharge chamber and subsequently the surface of the lamp bulb, inter alia owing to convection of the hot gas. To keep the minimum temperature of the coldest spot at the surface of the discharge chamber sufficiently high, the discharge vessel must be comparatively small. The maximum temperature of approximately 1400 K must not be exceeded in the hottest spot, because otherwise the useful life of the lamp would be reduced owing to recrystallization of the lamp bulb.

It is furthermore preferred that the thermally conducting material is shaped as a sleeve and is arranged at a distance from the lamp bulb of less than approximately 500 μm, more preferably at a distance of less than approximately 200 μm. This arrangement is particularly suitable for mass manufacture. For example, metal sleeves may be inexpensively manufactured beforehand and mounted without increased requirements as regards the observance of usual manufacturing tolerances. Given small gap widths between the sleeve and the lamp bulb, however, a sufficient heat transmission, in particular by heat conduction and heat radiation, is still safeguarded.

It is alternatively preferred that the thermally conducting material is a foil or a coating arranged on the lamp bulb.

The choice of material for use as the thermally conducting material particularly favors aluminum and/or copper because of their comparatively good thermal conductivity and availability. The relative thermal conduction coefficients with respect to the value of the thermal conduction coefficient of silver, silver being a very good thermal conductor, are, for example: copper approximately 0.95, aluminum approximately 0.585, and glass approximately 0.002.

It is furthermore preferred that the mutually corresponding surfaces of the lamp bulb and the thermally conducting material are identical or similar to a high degree as regards shape, geometry, and expansion. The desired heat transmission between the mutually corresponding regions of the lamp bulb and of the thermally conducting material can thus be realized particularly effectively.

It is alternatively provided that the mutually corresponding surfaces of the lamp bulb and of the thermally conducting material are not or only partly identical or similar as regards shape, geometry, and/or expansion. A suitable choice of these parameters of the thermally conducting material renders it possible, for example, to exert an additional influence on the temperature field, in particular in envisaged points or regions of the lamp bulb. These regions may be so cold in certain applications, for example where the electrodes enter the lamp bulb at the ends thereof, that a condensation effect or temperature stresses arise here. A suitable dimensioning of the thermally conducting material so as to serve as heat bridges provides a heat conduction towards these cold regions via said bridges.

The object of the invention is also achieved by means of a lighting unit which comprises at least one high-pressure gas discharge lamp as claimed in any one of the claims 1 to 7 as a light source.

The dependent claim 9 relates to advantageous further developments of the lighting unit according to the invention. The use of a lighting unit in accordance with the teachings of DE 101 51 267 A1 is preferred, in which a UHP lamp is used as the light source and the back reflector is arranged on the lamp bulb. This lighting unit achieves an increased efficiency in optical projection systems in particular owing to the reflectorization of part of the surface of the spherical discharge vessel. The object here is to allow as little visible light as possible to issue from the reflectorized portion of the bulb surface. Surface regions not covered by the back reflector serve in particular as light emission windows. The back reflector thus serves for the desired light emission of the high-pressure gas discharge lamp in an indirect manner and is arranged on the surface of a portion of the lamp bulb. The geometrical shape of the back reflector, which is dependent on its function, provides particularly favorable design possibilities as regards thermal conduction for the arrangement of the relevant thermally conducting material.

Further details, features, and advantages of the invention will become apparent from the ensuing description of a preferred embodiment, which is given with reference to the drawing in which:

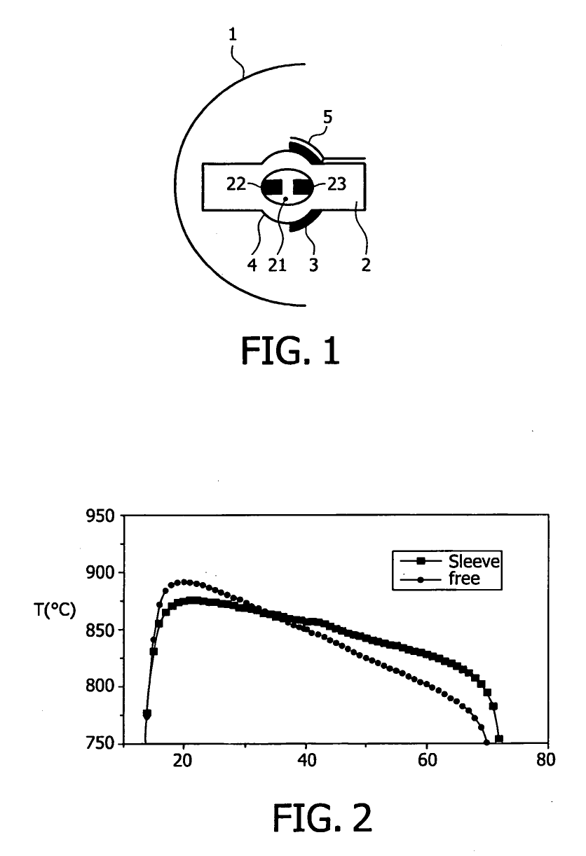

FIG. 1 diagrammatically shows a high-pressure gas discharge lamp (UHP lamp) in longitudinal sectional view, and

FIG. 2 shows measured values of a UHP lamp with and without sleeve.

FIG. 1 diagrammatically shows a high-pressure gas discharge lamp (UHP lamp) in longitudinal sectional view. A lamp bulb 2 has a discharge space 21 in which a usual discharge gas and an electrode arrangement are present. The electrode arrangement is formed by two electrodes 22, 23, between whose tips the gas discharge takes place in a known manner. The lamp bulb 2 and the main reflector 1 are mutually arranged such that the location of the actual light source, i.e. the region between the two electrodes 22, 23, lies substantially in the focus of the main reflector 1. A back reflector 3 in the form of a reflecting layer is present on the substantially spherical portion of the lamp bulb 2, which has an external diameter of approximately 9 mm. Possible arrangements of the layer structure and the corresponding material selections may be found, for example, in DE 101 51 267 A1. This portion of the surface is shaped such that light emitted from the gas discharge and incident on the back reflector 3 is reflected through the opening 4 onto the main reflector 1. The back reflector 3 is usually dimensioned such that it extends not quite up to halfway the region of the lamp bulb 2 surrounding the discharge space 21. The thermally conducting material in the form of a sleeve 5 is arranged adjacent the back reflector 3 substantially without mechanical contact thereto. The sleeve 5, in particular made of copper, is fastened to the UHP lamp in a usual manner, for example by means of an ignition antenna (not shown in FIG. 1) usual for this application. The sleeve 5 is arranged at a distance of less than approximately 200 μm from the lamp bulb 2, which renders possible a technically simple mounting and yet a good thermal transmission. The sleeve 5 therefore has a shape corresponding to the substantially spherical region of the lamp bulb 2 in this region. The dimensions of the sleeve 5 are chosen such that no additional shadow effect is caused in the light coming from the back reflector 3. Since the region below the sleeve 5 is reflectorized, little or no light reaches the surface of the sleeve 5, so that the optical properties of the lamp are not affected thereby. The high thermal conductivity of the sleeve 5 has the result that temperature gradients across the sleeve 5 are small in comparison with the temperature difference across the lamp bulb 2. The regions of the sleeve 5 close to the hottest and to the coldest spot of the adjoining lamp bulb 2 are substantially at one temperature level. The temperature gradients present between the sleeve 5 and the surface of the lamp bulb 2 achieve overall an energy flow from the hot to the cold regions of the lamp bulb 2.

The effects of the invention can be measured by means of a thermal imaging camera. A UHP lamp with and without sleeve 5 is operated at an electric power of approximately 120 W in the stationary condition. FIG. 2 shows the temperature gradient without a sleeve (dotted line) and with a sleeve (block line) in a diagram. The location of the temperature profile recorded from top to bottom is plotted from left to right on the X-axis, with the UHP lamp in horizontal position, i.e. the electrodes 22, 23 are on a horizontal axis. The temperature values in ° C. are plotted on the Y-axis.

The temperature registration (dotted line) without sleeve results in a temperature difference of approximately 124 K, with the hottest spot determined at approximately 907° C. and the coldest spot at approximately 783° C.

The temperature registration (block line) with sleeve 5 yields a temperature difference of approximately 70 K, with the hottest spot determined at approximately 887° C. and the coldest sot at approximately 817° C.

1. A high-pressure gas discharge lamp which comprises at least a lamp bulb (2) which hermetically seals off a gas-filled discharge space (21), which lamp bulb (2) has at least one region (3) which does not and/or does not directly serve for the desired light emission of the high-pressure gas discharge lamp, and in which region (3) a thermally conducting material is provided which has a higher thermal conductivity than the material of the lamp bulb (2).

2. A high-pressure gas discharge lamp as claimed in claim 1, characterized in that the lamp is a UHP lamp.

3. A high-pressure gas discharge lamp as claimed in claim 1, characterized in that the thermally conducting material is shaped as a sleeve (5) and is arranged at a distance of less than approximately 500 μm from the lamp bulb (2), more preferably at a distance of less than approximately 200 μm there from.

4. A high-pressure gas discharge lamp as claimed in claim 1, characterized in that the mutually corresponding surfaces of the lamp bulb (2) and of the thermally conducting material are substantially identical or similar as regards shape, geometry, and/or expansion.

5. A high-pressure gas discharge lamp as claimed in claim 1, characterized in that the mutually corresponding surfaces of the lamp bulb (2) and of the thermally conducting material are not or only partly identical or similar as regards shape, geometry, and/or expansion.

6. A high-pressure gas discharge lamp as claimed in claim 1, characterized in that the thermally conducting material is a foil or a coating which is arranged on the lamp bulb.

7. A high-pressure gas discharge lamp as claimed in claim 1, characterized in that the thermally conducting material comprises aluminum and/or copper.

8. A lighting unit comprising at least one high-pressure gas discharge lamp as claimed in claim 1 as a light source.

9. A lighting unit as claimed in claim 8, with a light source which is a UHP lamp, a main reflector, and a back reflector with an opening which is situated opposite the main reflector and through which light originating from the light source is reflected onto the main reflector, characterized in that the center of the light source is situated in a focal point of the back reflector, and the back reflector is provided on the lamp bulb.
